(19) United States
(12) Patent Application Publication
(10) Pub. No.: US 2016/0128453 A1
(43) Pub. Date: May 12, 2016

(54) Message Creation and Display Vessel

(71) Applicant: Melanie Ann Beard, Louisville, CO (US)

(72) Inventor: Melanie Ann Beard, Louisville, CO (US)

(21) Appl. No.: 14/936,913

(22) Filed: Nov. 10, 2015

Related U.S. Application Data
(60) Provisional application No. 62/077,316, filed on Nov. 10, 2014.

(51) Int. Cl. A45F 3/20; B43L 1/00; G09F 3/02

(52) U.S. Cl. CPC A45F 3/20; G09F 3/02; B43L 1/00; G09F 2003/0255; G09F 2003/0273

(57) ABSTRACT

A message creation and display vessel includes a fluid containing vessel with a base that extends into a flexible surrounding sidewall that terminates in an aperture portion. Further included is a waterproof flexible message display face adhered to a portion of the flexible surrounding sidewall. Also included is a message inscription implement that is adjacent to the vessel, the message inscription implement has an ink that can create a message on the waterproof display face while wet with water. Further the ink can be manually removed from the waterproof display face, to operationally facilitate a message to be added and removed from the message display face in a water wet external environment.

### RELATED PATENT APPLICATION

This application claims the benefit of U.S. provisional patent application Ser. No. 62/077,316 filed on Nov. 10, 2014 by Melanie Ann Beard of Louisville, Colo., U.S.

### TECHNICAL FIELD

The present invention relates generally to the conveyance of information on a suitable medium. More particularly, the present invention of the message creation and display vessel allows for the tracking and measurement of an exercise routine while performing the exercise routine in an aquatic environment.

### BACKGROUND OF INVENTION

To add purpose and progress to any exercise routine, the progress on the exercise routine must be tracked to enable an individual to stay on a program tracking such things as distance, times, laps, types of exercise, repetitions, amount of weight, and even bodily functions such as heart rate, etc., all cumulative over time, hence the explosion of electronic exercise tracking devices that evolved essentially from the basic pedometer that an individual wore around their waist. Still a number of exercise routines are tracked manually by individuals, i.e. pencil and paper type arrangements, which is what one will typically find in a weight room. However, now moving to the popular exercise of swimming, which has numerous added benefits that are well known for cardiovascular benefit, low joint stress, and the ability to exercise the entire body, there is not an easy way of tracking an individual's exercise routine, wherein the new electronic exercise tracking devices are not well suited for an aquatic environment, without cumbersome and expensive water proof enclosures, plus of course pencil and paper will not work in an aquatic environment. So there remains a need for a device to easily track an individual's exercise routine in an aquatic environment while swimming for instance.

In looking at the prior art in this area, in U.S. Pat. No. 7,971,710 to Zaher disclosed is a workout aid including a beverage container, and a removable band secured about the beverage container outer surface, see FIG. 2, the band comprising a first surface and a second surface, wherein at least a portion of the first surface is matingly engaged against the beverage container. Zaher further includes a first end and a second end, a means for detachably securing the first end of the band to the second end of the band, and wherein the second surface of the band is opposite from the first surface and has a schedule printed thereon or viewable therethrough, wherein the schedule includes a plurality of cells arranged in at least one column and at least one row. Zaher has a permanent preprinted workout schedule with days, times, reps, distance, and exercise names on the band with empty spaces for manually inputting workout data. Note that Zaher uses a hook and loop fastener for removably engaging the band to the beverage container outer surface, wherein hook and loop fasteners lose significant adhesion if immersed in water making Zaher unsuitable for an aquatic environment.

Continuing in the prior art, in U.S. Pat. No. 6,793,075 to Jeter disclosed is a drinking cup having a spill proof lid and a container. In Jeter, the lid fits onto the container, wherein the container has a place to write information, typically a paper card that is inserted in slots, such as a medication dosage. Further in Jeter, the container also scaled gradations to determine the volume of fluid in the container. In Jeter, the place to write information is a removable panel that is held in place with slots 18c as shown in FIG. 1, or integral with the cup sidewall as being a frosted surface area for a roughened writing area, see FIG. 2, it is presumed that the drinking cup is a substantially rigid enclosure due to it having a construction of hard plastic or glass, see column 1, lines 57-58. Further in Jeter, the writing is tied in with the fluid level gradations for medicine dosage applications.

Next, in the prior art in U.S. Pat. No. 4,906,025 to Schreindl disclosed is a wristband that is provided with a rectangular write-on surfaced mounting plate fastened centrally between opened ends on the outer surface of the wristband in longitudinal alignment with the wristband. The wristband in Schreindl is adjustable to the wrist size of the wearer and can be worn around the wearer's wrist held by fasteners attaching the opened ends together. In Schreindl, the surface of the mounting plate is a smooth non-porous plastic designed to be written on with dry-erase markers and erased by wiping with a tissue with a snap-on transparent covering being provided to prevent smearing the already in place writing from rain, sweat, and the like, the transparent covering is replaceable by a decorative opaque cap. The caps in Schreindl can be snapped onto the mounting base, wherein some caps are hinged to one end of the mounting base and snap down over the other end. Further, in Schreindl writing on the write-on mounting base or on an inserted card can be viewed through the transparent covering. Also, in Schreindl when the decorative opaque covering is in use, a small concealed storage space is provided between the cover and the write-on surface of the mounting base. Schreindl is designed for water droplets disposing upon the writing surface, however, not being designed for water immersion with the inserted card; see FIG. 8, wherein in Schreindl the writing could not be modified in a wet environment.

Yet further, in the prior art in U.S. Pat. No. 8,034,433 to Fai, et al. disclosed is an article, such as a cup or eating utensil, see FIGS. 1 to 5, including a writing surface for identification that includes a surface, a recess on the surface of the article for receiving the writing surface, and a writing surface formed of a waterproof material disposed in the recess. In Fai, a method of making an article with a writing surface includes providing an article with a recess in a surface of the article, and attaching a writing surface formed of a waterproof material in the recess. Fai is designed for a one-time identification to be added to the cup or eating utensil and not for writing and removing text while in a wet environment.

Continuing, in the prior art in U.S. Pat. No. 8,556,637 to Domey, et al., disclosed is a method of forming a writable erasable area on an object that includes selecting a glass sheet having a front surface and a back surface, where the front surface is opposed to and parallel to the back surface. In Domey, an area of the object where the writable erasable area is to be located is selected, and then the selected area has a select non-flat shape. Thus in Domey, the shape of the glass sheet is conformed to the select non-flat shape and the glass sheet is then mounted on the object such that the glass sheet is located at the selected area of the object and conforms in shape to the selected area of the object however, being rigid once the shape is formed, thus Domey would not be usable on a flexible surface.

What is needed is a message creation and display vessel that is specifically adapted for use in an aquatic environment wherein a squeezable flexible water bottle is used that can be written on in an erasable manner upon a portion of the water bottle outer surface for tracking and measurement of an exercise routine. The message creation and display vessel would have an integral and permanently attached writing surface requiring minimal effort to use that would allow the written text to be added to and erased in a wet environment.

### SUMMARY OF INVENTION

Broadly, the present invention of a message creation and display vessel includes a vessel having a longitudinal axis, the vessel including a base that extends into a flexible surrounding sidewall that terminates in an aperture portion. Wherein, the flexible surrounding sidewall is about the longitudinal axis, wherein the base and the aperture portion are oppositely disposed from one another along the longitudinal axis. The surrounding sidewall having an outer surface and an opposing inner surface, the flexible surrounding sidewall inner surface, the base, and the aperture portion defining an interior of the vessel that contains a fluid. Wherein, operationally manually squeezing the flexible surrounding sidewall results in the fluid being expelled therethrough the aperture portion from the vessel interior to an external environment.

Further included in the message creation and display vessel is a message display face that is constructed of a waterproof flexible laminate that includes a primary side and an opposing secondary side, the waterproof flexible laminate is flexibly affixed on the primary side with a water proof adhesive to a portion of the flexible surrounding sidewall outer surface, the flexible laminate secondary side facing the external environment, the waterproof flexible laminate is preferably constructed of a polymeric material.

Also included in the message creation and display vessel is a message inscription implement that is adjacent to the vessel, the message inscription implement has an ink that can create a message on the waterproof flexible laminate secondary side while wet with water. Further the ink can be manually removed from the waterproof flexible laminate secondary side, to operationally facilitate a message to be added and removed from the message display face in a water wet external environment.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a front perspective view of the message creation and display vessel showing the vessel base, the longitudinal axis, the surrounding sidewall, the aperture portion, the message display face, the portion of the surrounding sidewall, the message inscription implement, and the external environment that is water wet;

FIG. 2 shows a front elevation view of the message creation and display vessel showing the vessel base, the longitudinal axis, the surrounding sidewall, the aperture portion, the message display face, the portion of the surrounding sidewall, the message inscription implement, and the external environment that is water wet;

FIG. 3 shows cross sectional view 3-3 from FIG. 1 that shows the flexible surrounding sidewall, the longitudinal axis, the sidewall outer surface, the sidewall inner surface, the message display face water proof flexible laminate, the primary side of the water proof flexible laminate, the secondary side of the water proof flexible laminate, and the water proof adhesive;

FIG. 4 shows a front elevation view of the message creation and display vessel showing the vessel base, the longitudinal axis, the surrounding sidewall, the message display face secondary side, the portion of the surrounding sidewall, and a typical message inscription on the message display face secondary side for the purpose of the tracking and measurement of an exercise routine while performing the exercise routine in an aquatic environment;

FIG. 5 shows a front perspective use view of the message creation and display vessel showing the vessel base, the longitudinal axis, the surrounding sidewall, the aperture portion, the message display face, the portion of the surrounding sidewall, the external environment that is water wet, wherein a user is manually squeezing with their hand the flexible surrounding sidewall to expel the fluid therethrough the aperture portion from the vessel interior to the external environment as the message display face continues to display the inscription for the purpose of the tracking and measurement of the exercise routine while performing the exercise routine in an aquatic environment;

FIG. 6 shows a front perspective view of the alternative embodiment of the message creation and display vessel showing the vessel base, the longitudinal axis, the surrounding sidewall, the aperture portion, wherein the vessel surrounding sidewall is being rotated about the longitudinal axis to be exposed to a heat producing element making the surrounding sidewall more receptive to the silk screen ink printing;

FIG. 7 shows a side elevation view of the vessel wherein the vessel is being rotated about the longitudinal axis for the surrounding sidewall to be in momentary static contact with an inked silkscreen that is laterally moving in accord with the surrounding sidewall rotation, wherein a printed area results from the silk screen and ink onto the surrounding sidewall in a portion of the outer sidewall surface forming a message display face;

FIG. 8 shows a front perspective view of the alternative embodiment of the message creation and display vessel showing the vessel base, the longitudinal axis, the surrounding sidewall, the aperture portion, the message display face, the portion of the surrounding sidewall, and the external environment that is for curing the silk screened ink via a curing light;

FIG. 9 shows a front elevation view of the alternative embodiment of the message creation and display vessel showing the vessel base, the longitudinal axis, the surrounding sidewall, the aperture portion, the message display face from the silk screened ink, the portion of the surrounding sidewall, the message inscription implement, and the external environment that is water wet;

FIG. 10 shows a front perspective view of the alternative embodiment of the message creation and display vessel showing the vessel base, the longitudinal axis, the surrounding sidewall, the aperture portion, the message display face from the silk screened ink, the portion of the surrounding sidewall, the message inscription implement, and the external environment that is water wet;

FIG. 11 shows cross sectional view 11-11 from FIGS. 8 and 10 that shows the flexible surrounding sidewall, the longitudinal axis, the sidewall outer surface, the sidewall inner surface, and the message display face water proof printed area of the silk screen;

FIG. 12 shows a front elevation view of the alternative embodiment of the message creation and display vessel showing the vessel base, the longitudinal axis, the surrounding sidewall, the message display face, the portion of the surrounding sidewall, and a typical message inscription on the message display face for the purpose of the tracking and measurement of an exercise routine while performing the exercise routine in an aquatic environment; and

FIG. 13 shows a front perspective use view of the alternative embodiment of the message creation and display vessel showing the vessel base, the longitudinal axis, the surrounding sidewall, the aperture portion, the message display face, the portion of the surrounding sidewall, the external environment that is water wet, wherein a user is manually squeezing with their hand the flexible surrounding sidewall to expel the fluid therethrough the aperture portion from the vessel interior to the external environment as the message display face continues to display the inscription for the purpose of the tracking and measurement of the exercise routine while performing the exercise routine in an aquatic environment.

### REFERENCE NUMBERS IN DRAWINGS

50 Message creation and display vessel
55 External environment
60 Water wet external environment 55
65 Vessel
70 Longitudinal axis of the message creation and display vessel 50, 200
75 Base of the vessel 65
80 Aperture portion of the vessel 65
85 Flexible surrounding sidewall of the vessel 65
90 Outer surface of the sidewall 85
95 Inner surface of the sidewall 85
100 Portion of the sidewall outer surface 90
105 Interior of the vessel 65
110 Fluid
115 Manually squeezing the flexible surrounding sidewall 85
120 Fluid 110 being expelled therethrough the aperture portion 80
125 Message display face area
130 Waterproof flexible laminate of the message display face 125
135 Primary side of the waterproof flexible laminate 130
140 Secondary side of the waterproof flexible laminate 130
145 Water wet of the secondary side 140 of the waterproof flexible laminate 130 or printed area 235 of the silk screen 215 ink 220
150 Flexible affixment of the waterproof flexible laminate 130 to the portion 100 of the outer surface 90 of the flexible surrounding sidewall 85
155 Water proof adhesive of the flexible affixment 150
160 Message inscription implement
161 Means for removably engaging the message inscription implement 160 from the surrounding sidewall 85
162 Hook and loop fastener for the means 161 for removably engaging the message inscription implement 160 from the surrounding sidewall 85
170 Ink for the message inscription implement 160
175 Text for tracking and measurement of an exercise routine on the secondary side 140 of the waterproof flexible laminate 130 or printed area 235 of the silk screen 215 ink 220
200 Message creation and display vessel alternative embodiment
205 Heat producing element to preheat the outer surface 90 of the sidewall 85
210 Rotational movement of the vessel 65 about the longitudinal axis 70 to evenly distribute the heat from element 205 over the outer surface 90 of the sidewall 85 to prep the outer surface 90 of the sidewall 90 for the ink 220
215 Silk screen
220 Ink for the silk screen 215
225 Lateral movement of the silk screen 215
230 Rotational movement of the vessel 65 about the longitudinal axis 70 that is in accord with lateral movement 225 of the silk screen 215 to evenly distribute the silk screen 215 ink 220 to print over the outer surface 90 of the sidewall 85 forming the printed area 235
235 Printed area of the silk screen 215 ink 220 layer
240 Curing external environment 55 for the printed area 235 of the silk screen 215 ink 220
245 Light for creating a curing external environment 240

### DETAILED DESCRIPTION

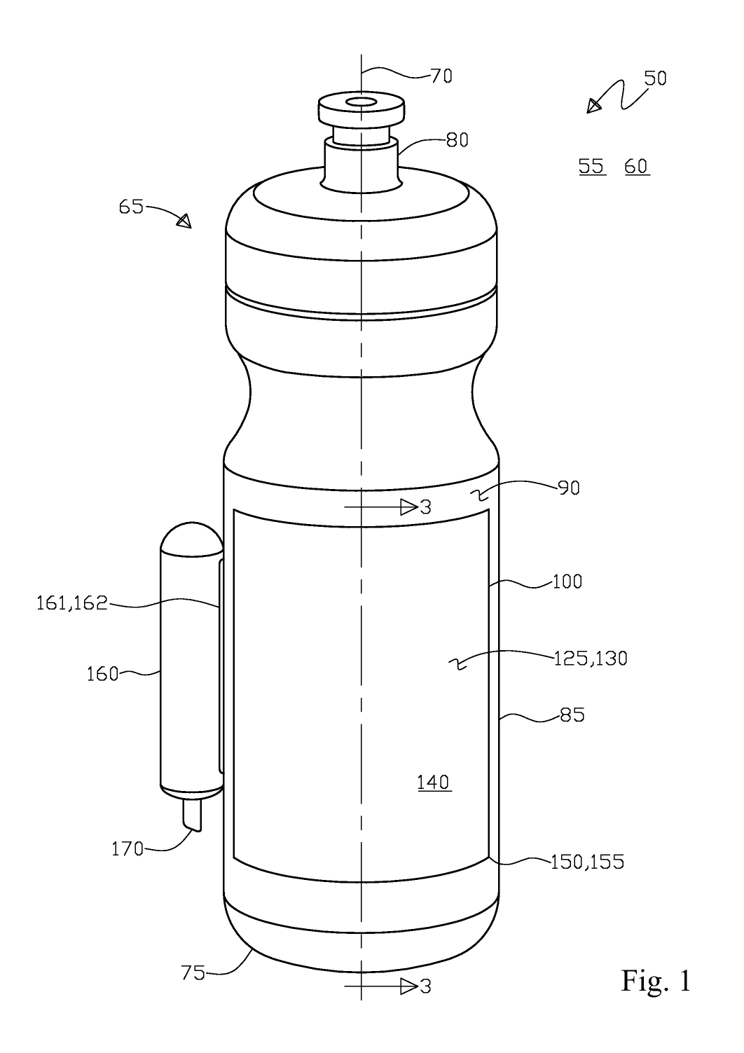

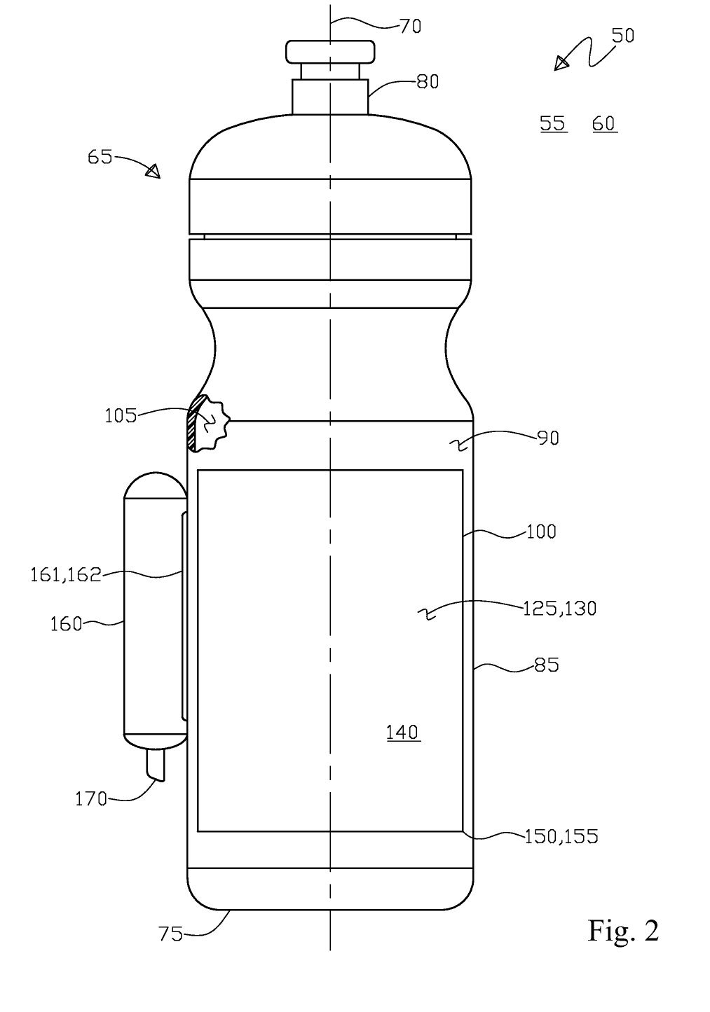

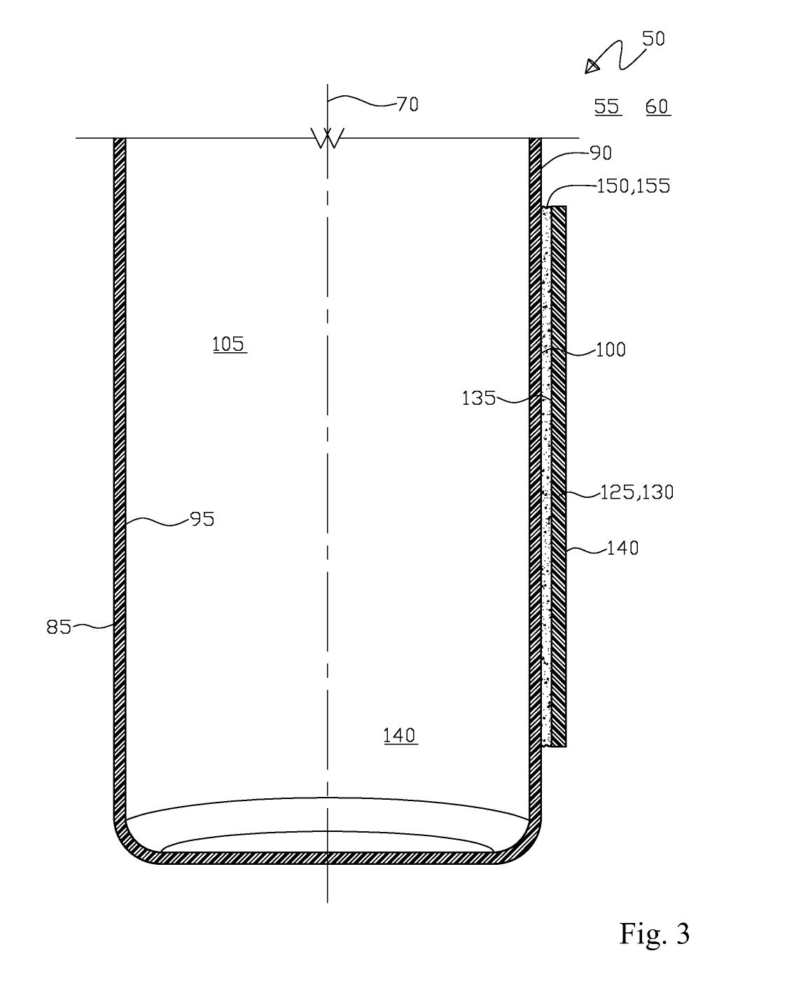

With initial reference to FIG. 1, shown is a front perspective view of the message creation and display vessel 50 showing the vessel 65, the base 75, the longitudinal axis 70, the surrounding sidewall 85, the aperture portion 80, the message display face 125, the portion 100 of the surrounding sidewall 85, the message inscription implement 160, and an external environment 55 that is water wet 60. Next, FIG. 2 shows a front elevation view of the message creation and display vessel 50 showing the vessel 65, the base 75, the longitudinal axis 70, the surrounding sidewall 85, the aperture portion 80, the message display face 125, the portion 100 of the surrounding sidewall 85, the message inscription implement 160, and the external environment 55 that is water wet 60. Continuing, FIG. 3 shows cross sectional view 3-3 from FIG. 1 that shows the flexible surrounding sidewall 85, the longitudinal axis 70, the sidewall 85 outer surface 90, the sidewall 85 inner surface 95, the message display face 125 water proof flexible laminate 130, the primary side 135 of the water proof flexible laminate 130, the secondary side 140 of the water proof flexible laminate 130, and the water proof adhesive 155.

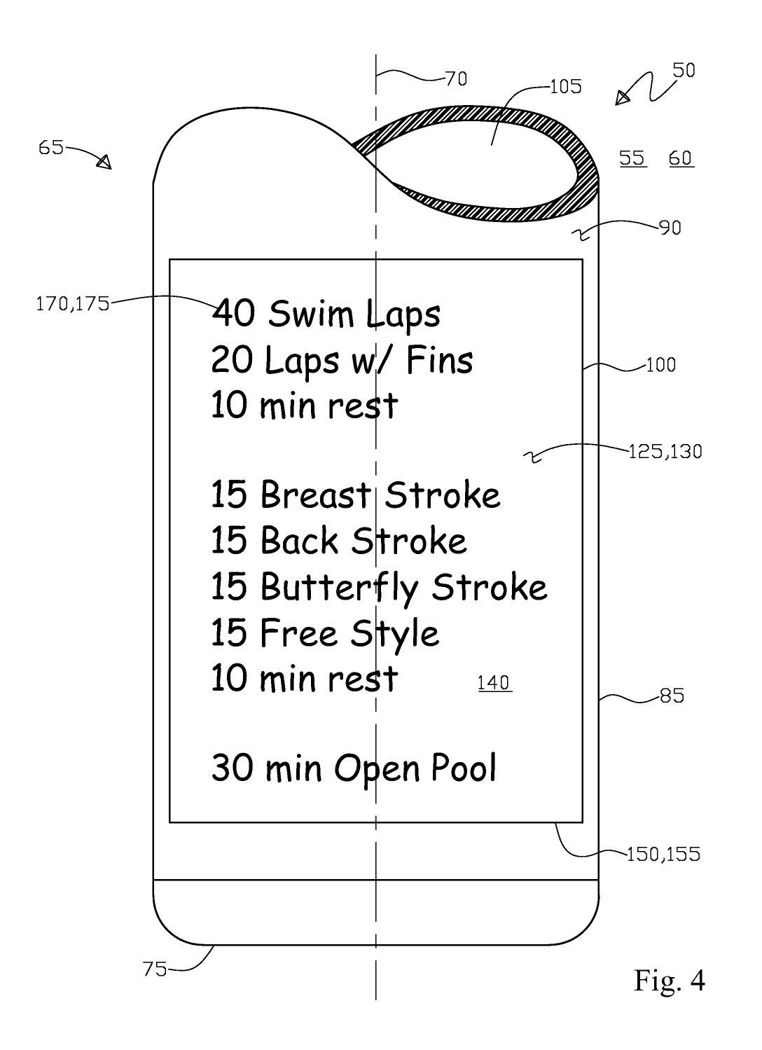

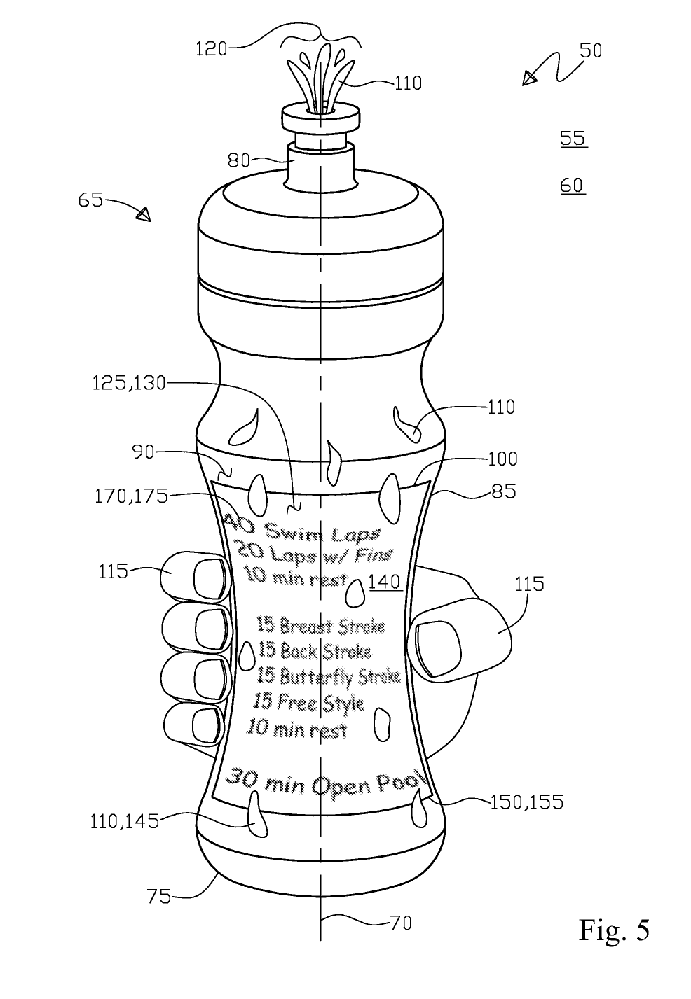

Further, FIG. 4 shows a front elevation view of the message creation and display vessel 50 showing the vessel 65, the base 75, the longitudinal axis 70, the surrounding sidewall 85, the message display face 125 secondary side 140, the portion of the surrounding sidewall 85, and a typical message inscription 175 on the message display face 125 secondary side 140 for the purpose of the tracking and measurement of an exercise routine while performing the exercise routine in an aquatic or water wet environment 60. Continuing, FIG. 5 shows a front perspective use view of the message creation and display vessel 50 showing the vessel 65, the base 75, the longitudinal 70 axis, the surrounding sidewall 85, the aperture portion 80, the message display face 125, the portion 100 the surrounding sidewall 85, and the external environment 55 that is water wet 60. Also, in FIG. 5 the user 115 is manually squeezing 115 with their hand 115 the flexible surrounding sidewall 85 to expel 120 the fluid 110 therethrough the aperture portion 80 from the vessel 65 interior 105 to the external environment 55 as the message display face 125 continues to display the inscription 175 for the purpose of the tracking and measurement of the exercise routine while performing the exercise routine in an aquatic or water wet environment 60.

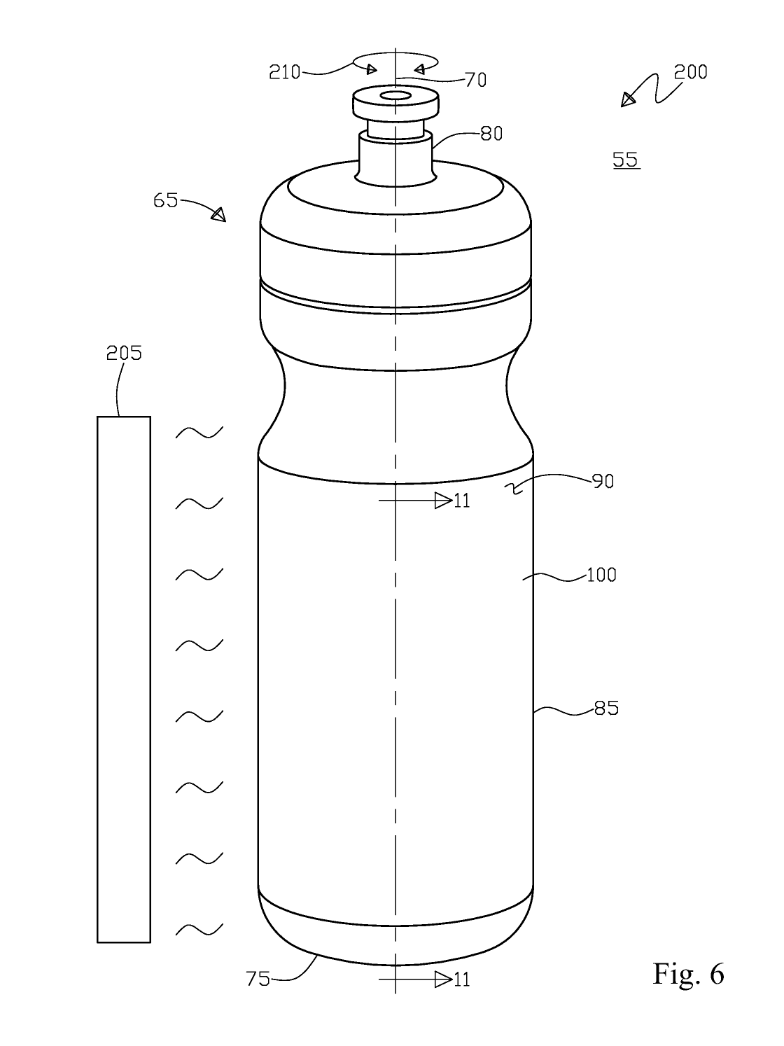

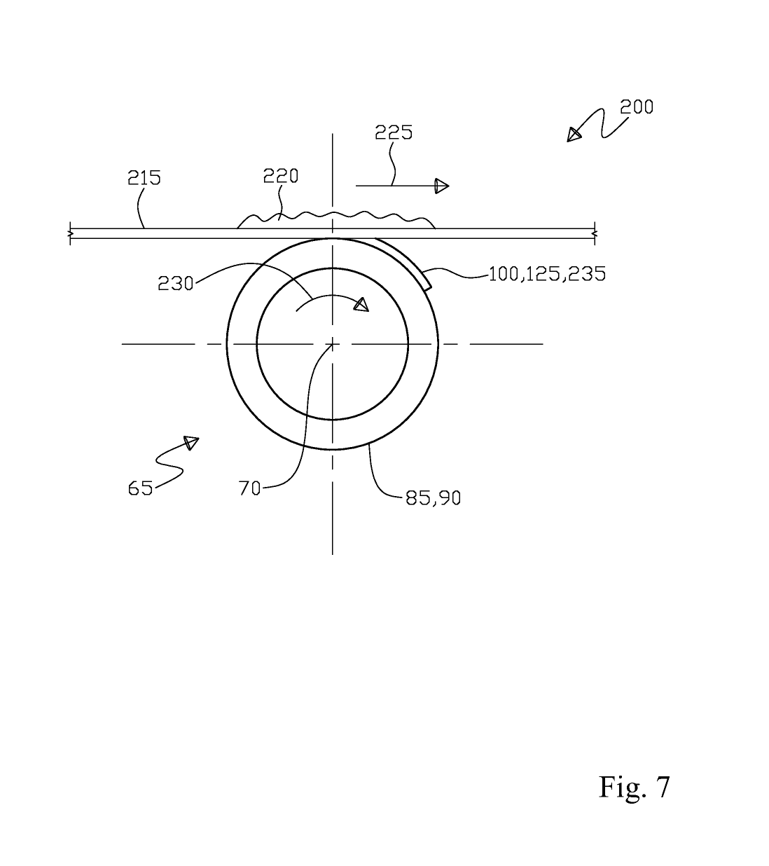

Next, FIG. 6 shows a front perspective view of the alternative embodiment of the message creation and display vessel 200 showing the vessel base 75, the longitudinal axis 70, the surrounding sidewall 85, the aperture portion 80, wherein the vessel 65 surrounding sidewall 85 is being rotated 210 about the longitudinal axis 70 to be exposed to a heat producing element 205 making the surrounding sidewall 85 more receptive to the silk screen 215 ink 220 printing. Continuing, FIG. 7 shows a side elevation view of the vessel 65 wherein the vessel 65 is being rotated 230 about the longitudinal axis 70 for the surrounding sidewall 85 to be in momentary static contact with an inked 220 silkscreen 215 that is laterally moving 225 in accord with the surrounding sidewall 85 rotation 230, wherein a printed area 235 results from the silk screen 215 and ink 220 onto the surrounding sidewall 85 in a portion 100 of the outer sidewall surface 90 forming a message display face 125.

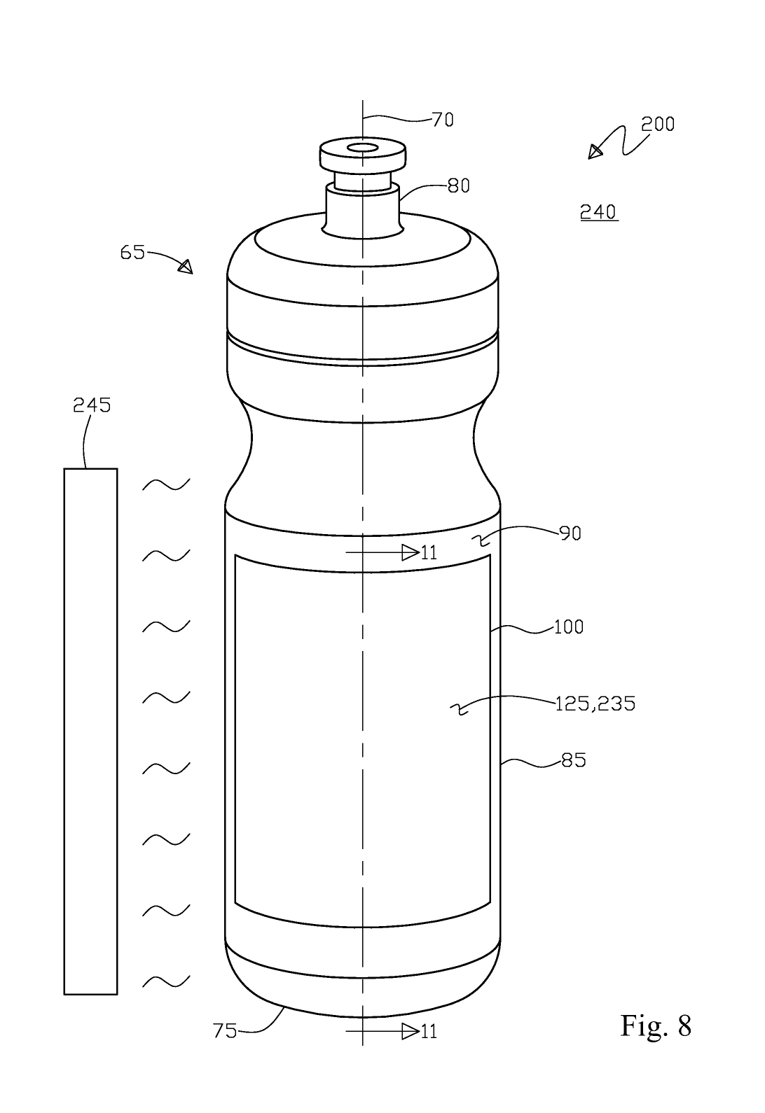

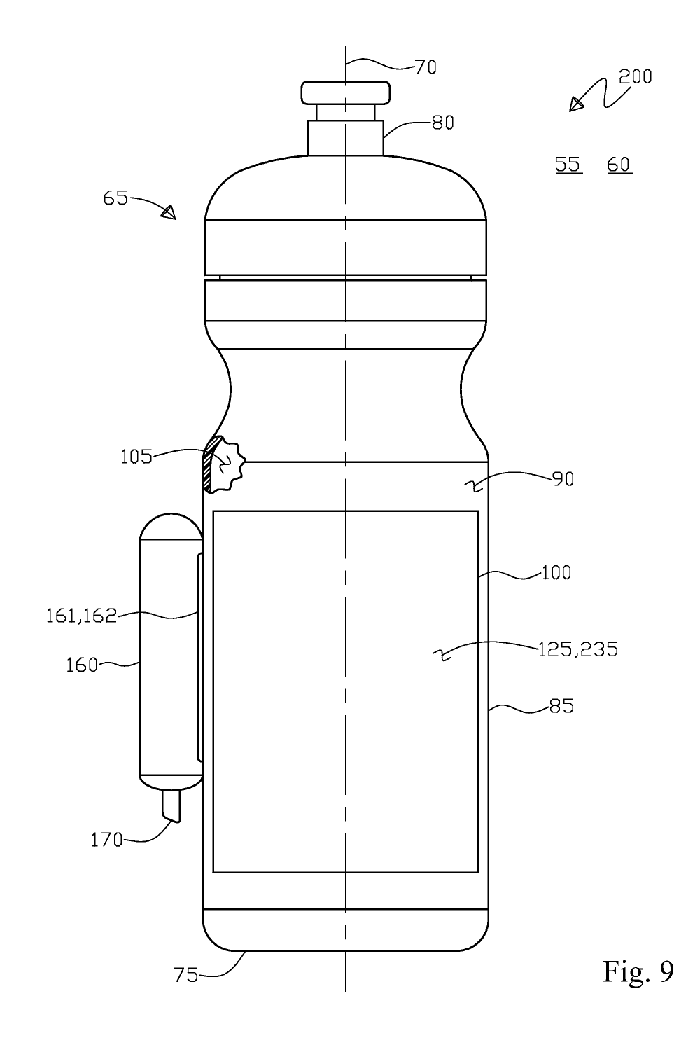

Further, FIG. 8 shows a front perspective view of the alternative embodiment of the message creation and display vessel 200 showing the vessel base 75, the longitudinal axis 70, the surrounding sidewall 85, the aperture portion 80, the message display face 125, the portion 100 of the surrounding sidewall 85, and the external environment 240 that is for curing the silk screened 215 ink 220, via a curing light 245. Next, FIG. 9 shows a front elevation view of the alternative embodiment of the message creation and display vessel 200 showing the vessel base 75, the longitudinal axis 70, the surrounding sidewall 85, the aperture portion 80, the message display face 125 from the silk screened 215 ink 220, the portion 100 of the surrounding sidewall 85, the message inscription implement 160, and the external environment that is water wet 60.

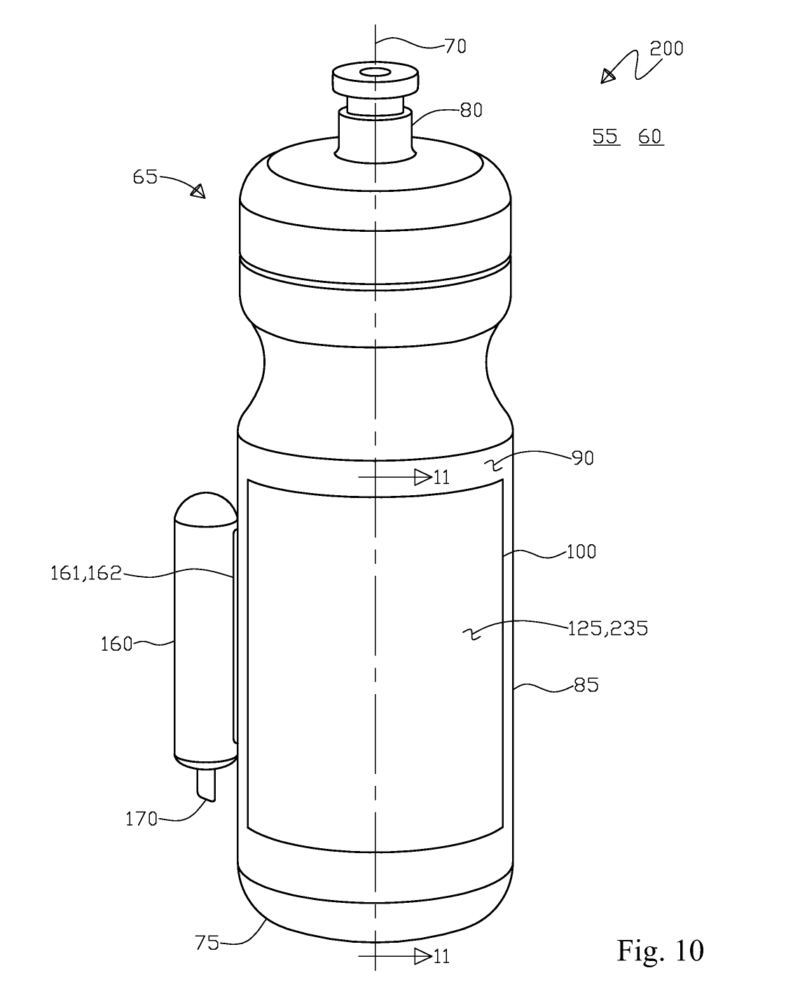

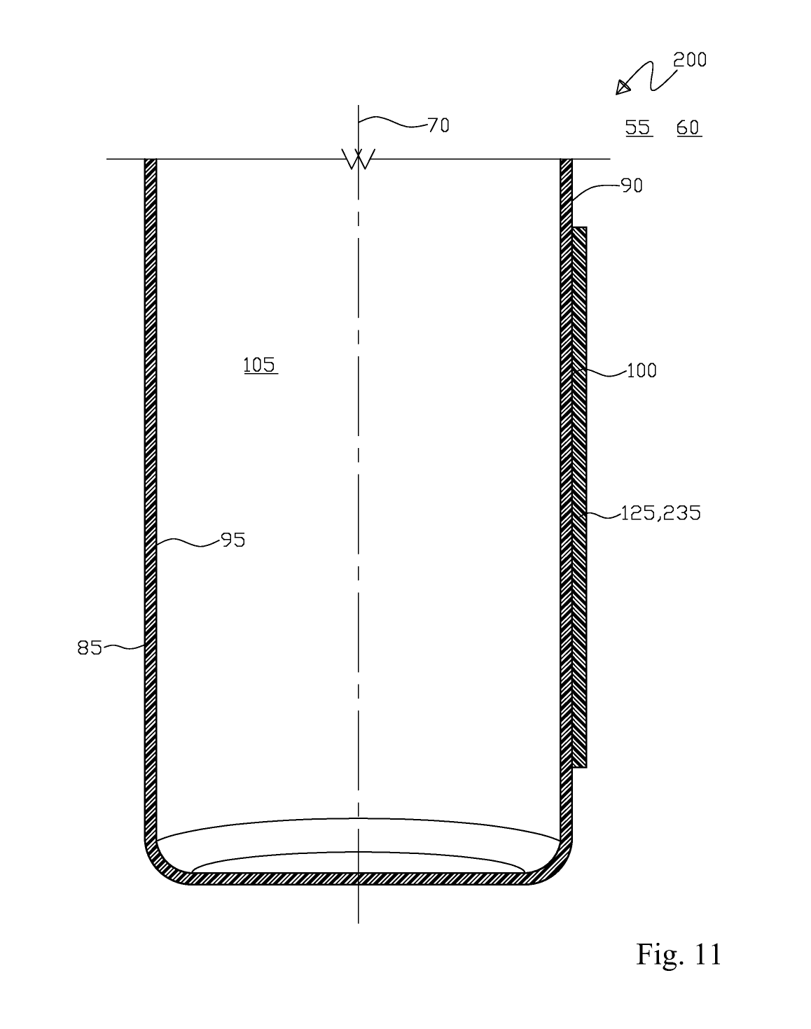

Moving onward, FIG. 10 shows a front perspective view of the alternative embodiment of the message creation and display vessel 200 showing the vessel base 75, the longitudinal axis 70, the surrounding sidewall 85, the aperture portion 80, the message display face 125 from the silk screened 215 ink 220, the portion 100 of the surrounding sidewall 85, the message inscription implement 160, and the external environment 55 that is water wet 60. Further, FIG. 11 shows cross sectional view 11-11 from FIGS. 8 and 10 that shows the flexible surrounding sidewall 85, the longitudinal axis 70, the sidewall outer surface 90, the sidewall inner surface 95, and the message display face 125 water proof printed area 235 of the silk screen 215.

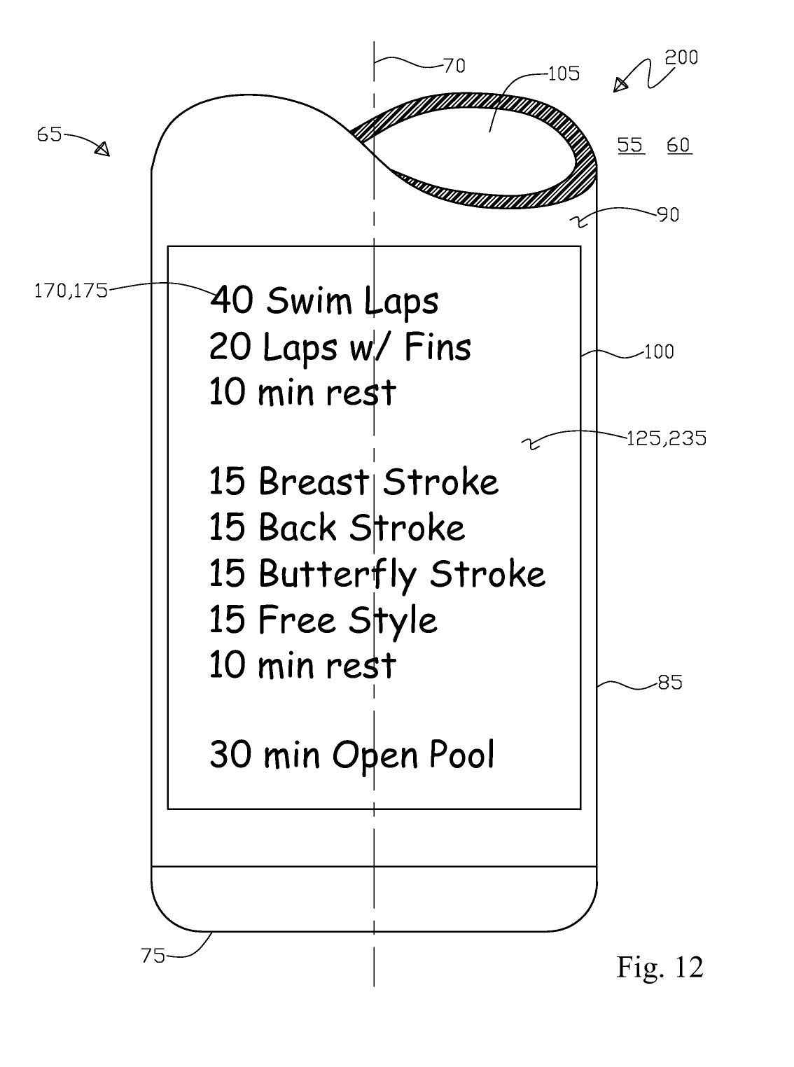

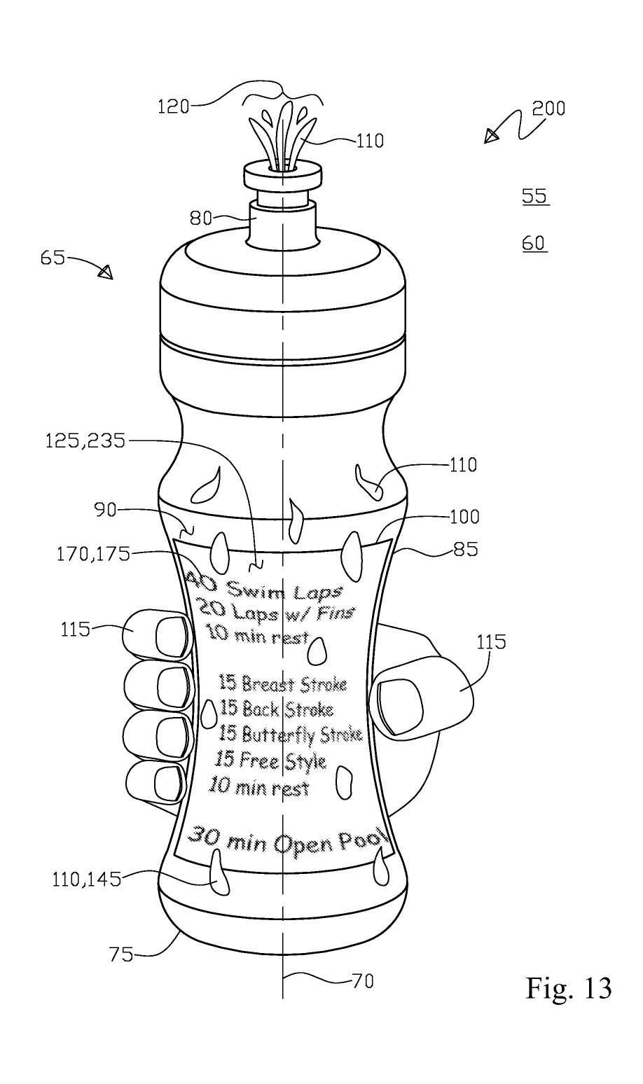

Continuing, FIG. 12 shows a front elevation view of the alternative embodiment of the message creation and display vessel 200 showing the vessel base 75, the longitudinal axis 70, the surrounding sidewall 85, the message display face 125, the portion 100 of the surrounding sidewall 85, and a typical message inscription 170, 175 on the message display face 125 for the purpose of the tracking and measurement of an exercise routine while performing the exercise routine in an aquatic environment 60. Also, FIG. 13 shows a front perspective use view of the alternative embodiment of the message creation and display vessel 200 showing the vessel base 75, the longitudinal axis 70, the surrounding sidewall 85, the aperture portion 80, the message display face 125, the portion 100 of the surrounding sidewall 85, the external environment 55 that is water wet 60. Wherein FIG. 13 shows a user is manually squeezing 115 with their hand the flexible surrounding sidewall 85 to expel the fluid 110 therethrough 120 the aperture portion 80 from the vessel interior 105 to the external environment 55 as the message display face 125 continues to display the inscription 170, 175 for the purpose of the tracking and measurement of the exercise routine while performing the exercise routine in an aquatic environment 60.

In looking at FIGS. 1 to 4, the present invention of the message creation and display vessel 50 includes the vessel 65 having the longitudinal axis 70, the vessel 65 including the base 75 that extends into the flexible surrounding sidewall 85 that terminates in the aperture portion 80, see in particular FIGS. 1, 2, and 5. Wherein the flexible surrounding sidewall 85 is about the longitudinal axis 70 and the base 75 and the aperture portion 80 are oppositely disposed from one another along the longitudinal axis 70, as best shown in FIGS. 1, 2, and 3. The surrounding sidewall 85 having the outer surface 90 and the opposing inner surface 95, see FIG. 3, wherein the flexible surrounding sidewall 85 inner surface 95, the base 75, and the aperture portion 80 all act to define the interior 105 of the vessel 65 that contains the fluid 110, as best shown in FIGS. 2, 3, and 4. Wherein operationally, looking at FIG. 5 in particular, manually squeezing 115 the flexible surrounding sidewall 85 results in the fluid 110 being expelled 120 therethrough the aperture portion 80 from the vessel 65 interior 105 to an external environment 55.

Further included in the message creation and display vessel 50 is a message display face 125 that is constructed of a waterproof flexible laminate 130 that includes the primary side 135 and the opposing secondary side 140, the waterproof flexible laminate 130 is flexibly affixed 150 on the primary side 135 with the water proof adhesive 155 to the portion 100 of the flexible surrounding sidewall 85 outer surface 90, wherein the flexible laminate 130 secondary side 140 faces the external environment 55, the waterproof flexible laminate 130 is preferably constructed of a polymeric material, see FIG. 3 in particular, and also see FIGS. 1, 2, and 4.

Also included in the message creation and display vessel 50 is a message inscription implement 160 that is adjacent to the vessel 65, the message inscription implement 160 has an ink 170 that can create the message 175 on the waterproof flexible laminate 130 secondary side 140 while wet 145, 110 with water 60. Further the ink 170 can be manually removed from the waterproof flexible laminate 130 secondary side 140, to operationally facilitate the message 175 to be manually added and manually removed from the message display face 125 in a water wet 60 external environment 55.

For the alternative embodiment of the message creation and display vessel 200, the message display face 125 is preferably constructed of a printed ink waterproof flexible layer 220 that is applied to the portion 100 of the flexible surrounding sidewall 85 outer surface 90, wherein the printed ink waterproof flexible layer 220 is facing the external environment 55, see FIGS. 6 to 13. Further, for the alternative embodiment of the message creation and display vessel 200, for the message inscription implement 160 that is adjacent to the vessel 65, the message inscription implement 160 has an ink 170 that can create a message on the printed ink waterproof flexible layer 220 while wet with water, further the implement ink 170 can be manually removed from the printed ink waterproof flexible layer 220, to operationally facilitate a message 175 to be added and removed from the message display face 125 in a water wet external environment 60, again as in FIGS. 6 to 13, or in particular FIGS. 9, 10, 12, and 13.

As an option for the message creation and display vessel 50 or the alternative embodiment 200, the vessel 65 is preferably a sports water bottle that has a generally elongated cylindrical shape, see FIGS. 1 to 13. Further, as an another option for the message creation and display vessel 50 or the alternative embodiment 200, the message inscription implement 160 can further include a means 161 for removably engaging the message inscription implement 160 from the surrounding sidewall 85, see FIGS. 1, 2, 9, and 10. As a further option for the message creation and display vessel 50 or the alternative embodiment 200, the means 161 for removably engaging the message inscription implement 160 from the surrounding sidewall 85 is preferably constructed of a hook and loop fastener 162, again see FIGS. 1, 2, 9, and 10. As another option for the message creation and display vessel 50 or the alternative embodiment 200, the message inscription implement 160 can be selected from the group consisting of a permanent marker, a dry-erase marker, a wet-erase marker, and a grease pencil, again see FIGS. 1, 2, 9, and 10.

As an option in particular for the alternative embodiment message creation and display vessel 200, the printed ink waterproof flexible layer 220 is a light shaded single color that is substantially translucent, see FIGS. 7 to 13. Further, as an option in particular for the alternative embodiment message creation and display vessel 200, the printed ink waterproof flexible layer 220 can be a white color. Further, as another option in particular for the alternative embodiment message creation and display vessel 200, the printed ink waterproof flexible layer 220 is preferably an ultra violet (UV) type ink that is cured via ultra violet light 245 after the ultra violet ink 220 is applied to the surrounding sidewall 85, the ultra violet ink 220 is preferably light or white in a single color to facilitate the ultra violet light 245 penetrating the translucent ultra violet ink layer 220 for effective curing, see in particular FIG. 8 and generally FIGS. 6, 7, and 9 to 13.

### Method of Manufacturing

Looking at FIGS. 6, 7, and 8, disclosed is a method of manufacturing the alternative embodiment of the message creation and display vessel 200, comprising the steps of, firstly providing the vessel 65 as previously described, see FIGS. 1 to 13. A second step of providing the silkscreen 215 with the display face area 125 to cover the portion 100 of the surrounding sidewall 85 outer surface 90, again see FIGS. 1 to 13. Next, a third step of positioning the silkscreen 215 display face area 125 to be adjacent to the portion 100 of said surrounding sidewall 85 outer surface 90, see in particular FIG. 7. Subsequently, a fourth step of providing a waterproof ultra violet ink 220 in a single translucent light color, as shown in FIG. 7 and a fifth step of positioning the ultra violet ink 220 to be adjacent to the silk screen 215 display face area 125 opposite of the portion 100 of the surrounding sidewall 85 outer surface 90, again see in particular FIG. 7,

Further, a sixth step of rotating 230 the vessel 65 about the longitudinal axis 70 and a simultaneous seventh step of moving laterally 225 the silkscreen 215 simultaneously with the vessel 65 rotating 230, again see in particular FIG. 7. Next, an eighth step of transferring the display face area 125 in the ultra violet ink 220 to the portion 100 of the sidewall 85 outer surface 90 via the rotating 230 and the moving 225 steps. Then, a ninth step of exposing the ultra violet ink 220 on the portion 100 of the sidewall 85 outer surface 90 to ultra violet light 245 to cure the ultra violet ink 220 resulting in forming a single color solid message display face 125 via the ultra violet ink 220 on the portion 100 of the sidewall 85 outer surface 90 to create a wet or dry waterproof writing area 125 for writing down 175 an exercise routine with a message inscription implement 160, wherein the written 175 exercise routine is removable with a solvent. As an option for the method of manufacturing the alternative embodiment of the message creation and display vessel 200, the fourth providing step of a waterproof ultra violet ink 220 in a single translucent light color is a single color of white.

### Method of Use

Looking at FIGS. 4, 5, 12, and 13 in particular and FIGS. 1, 2, 3, 6, 7, 8, 9, 10, and 11 in general, a method of using the message creation and display vessel 50 or the alternative embodiment 200, is disclosed comprising the steps of firstly providing the message creation and display vessel 50 or the alternative embodiment 200, of the message creation and display vessel as previously described. Next, a second step of writing an exercise routine 175 on the message display face 125 using the message inscription implement 160, see FIGS. 4, 5, 12, and 13. Further, a third step of completing the exercise routine 175 and using the vessel 65 and the fluid 110 for hydration during exercise and a fourth step of cleaning off the exercise routine 175 writing from the message display face 125 with a solvent.

Further, for the method of using the message creation and display vessel 50 or the alternative embodiment 200, for the cleaning step solvent is preferably selected from the group consisting of ketones and further to this the preferable ketone is acetone. In addition, an optional added step is of washing the vessel 65 either via manual washing or on the top rack of a dishwasher.

### CONCLUSION

Accordingly, the present invention of a message creation and display vessel has been described with some degree of particularity directed to the embodiments of the present invention. It should be appreciated, though; that the present invention is defined by the following claim construed in light of the prior art so modifications or changes may be made to the exemplary embodiments of the present invention without departing from the inventive concepts contained therein.

1. A message creation and display vessel, comprising
(a) a vessel having a longitudinal axis, said vessel including a base that extends into a flexible surrounding sidewall that terminates in an aperture portion, wherein said flexible surrounding sidewall is about said longitudinal axis and said base and said aperture portion are oppositely disposed from one another along said longitudinal axis, said surrounding sidewall having an outer surface and an opposing inner surface, said flexible surrounding sidewall inner surface, said base, and said aperture portion defining an interior of said vessel that contains a fluid, wherein operationally manually squeezing said flexible surrounding sidewall results in the fluid being expelled therethrough said aperture portion from said vessel interior to an external environment;
(b) a message display face that is constructed of a waterproof flexible laminate that includes a primary side and an opposing secondary side, said waterproof flexible laminate is flexibly affixed on said primary side with a water proof adhesive to a portion of said flexible surrounding sidewall outer surface, said flexible laminate secondary side facing the external environment, said waterproof flexible laminate is constructed of a polymeric material; and
(c) a message inscription implement that is adjacent to said vessel, said message inscription implement has an ink that can create a message on said waterproof flexible laminate secondary side while wet with water, further said implement ink can be manually removed from said waterproof flexible laminate secondary side, to operationally facilitate a message to be added and removed from said message display face in a water wet external environment.

2. A message creation and display vessel according to claim 1, wherein said vessel is a sports water bottle that has a generally elongated cylindrical shape.

3. A message creation and display vessel according to claim 1, wherein said message inscription implement further includes a means for removably engaging said message inscription implement from said surrounding sidewall.

4. A message creation and display vessel according to claim 3, wherein said means for removably engaging said message inscription implement from said surrounding sidewall is constructed of a hook and loop fastener.

5. A message creation and display vessel according to claim 1, wherein said message inscription implement is selected from the group consisting of a permanent marker, a dry-erase marker, a wet-erase marker, and a grease pencil.

6. A message creation and display vessel according to claim 1, wherein said waterproof flexible laminate is constructed of a polymeric material.

7. An alternative embodiment message creation and display vessel, comprising
(a) a vessel having a longitudinal axis, said vessel including a base that extends into a flexible surrounding sidewall that terminates in an aperture portion, wherein said flexible surrounding sidewall is about said longitudinal axis and said base and said aperture portion are oppositely disposed from one another along said longitudinal axis, said surrounding sidewall having an outer surface and an opposing inner surface, said flexible surrounding sidewall inner surface, said base, and said aperture portion defining an interior of said vessel that contains a fluid, wherein operationally manually squeezing said flexible surrounding sidewall results in the fluid being expelled therethrough said aperture portion from said vessel interior to an external environment;
(b) a message display face that is constructed of a printed ink waterproof flexible layer that is applied to a portion of said flexible surrounding sidewall outer surface, said printed ink waterproof flexible layer facing the external environment; and
(c) a message inscription implement that is adjacent to said vessel, said message inscription implement has an ink that can create a message on said printed ink waterproof flexible layer while wet with water, further said implement ink can be manually removed from said printed ink waterproof flexible layer, to operationally facilitate a message to be added and removed from said message display face in a water wet external environment.

8. An alternative embodiment message creation and display vessel according to claim 7, wherein said vessel is a sports water bottle that has a generally elongated cylindrical shape.

9. An alternative embodiment message creation and display vessel according to claim 7, wherein said message inscription implement further includes a means for removably engaging said message inscription implement from said surrounding sidewall.

10. An alternative embodiment message creation and display vessel according to claim 9, wherein said means for removably engaging said message inscription implement from said surrounding sidewall is constructed of a hook and loop fastener.

11. An alternative embodiment message creation and display vessel according to claim 7, wherein said message inscription implement is selected from the group consisting of a permanent marker, a dry-erase marker, a wet-erase marker, and a grease pencil.

12. An alternative embodiment message creation and display vessel according to claim 7, wherein said printed ink waterproof flexible layer is a light shaded single color that is substantially translucent.

13. An alternative embodiment message creation and display vessel according to claim 12, wherein said printed ink waterproof flexible layer is a white color.

14. An alternative embodiment message creation and display vessel according to claim 13, wherein said printed ink waterproof flexible layer is an ultra violet (UV) type ink that is cured via ultra violet light after said ultra violet ink is applied to said surrounding sidewall.

15. A method of manufacturing a message creation and display vessel comprising the steps of:
(a) providing a vessel that includes a longitudinal axis, said vessel including a base that extends into a flexible surrounding sidewall that terminates in an aperture portion, wherein said flexible surrounding sidewall is about said longitudinal axis and said base and said aperture portion are oppositely disposed from one another along said longitudinal axis, said surrounding sidewall having an outer surface and an opposing inner surface, said flexible surrounding sidewall inner surface, said base, and said aperture portion defining an interior of said vessel that contains a fluid, wherein operationally manually squeezing said flexible surrounding sidewall results in the fluid being expelled therethrough said aperture portion from said vessel interior to an external environment;
(b) providing a silkscreen with a display face area to cover a portion of said surrounding sidewall outer surface;
(c) positioning said silkscreen display face area to be adjacent to said portion of said surrounding sidewall outer surface;
(d) providing a waterproof ultra violet ink in a single translucent light color;
(e) positioning said ultra violet ink to be adjacent to said silk screen display face area opposite of said portion of said surrounding sidewall outer surface;
(f) rotating said vessel about said longitudinal axis;
(g) moving laterally said silkscreen simultaneously with said vessel rotating;
(h) transferring said display face area in said ultra violet ink to said portion of said sidewall outer surface via said rotating and said moving steps; and
(i) exposing said ultra violet ink on said portion of said sidewall outer surface to ultra violet light to cure said ultra violet ink resulting in forming a single color solid message display face via said ultra violet ink on said portion of said sidewall outer surface to create a wet or dry waterproof writing area for writing down an exercise routine with a message inscription implement, wherein said written exercise routine is removable with a solvent.

16. A method of manufacturing a message creation and display vessel according to claim 15 wherein said providing step of a waterproof ultra violet ink in a single translucent light color is a single color of white.

17. A method of using a message creation and display vessel comprising the steps of:
(a) providing a message creation and display vessel that includes a vessel having a longitudinal axis, said vessel including a base that extends into a flexible surrounding sidewall that terminates in an aperture portion, wherein said flexible surrounding sidewall is about said longitudinal axis and said base and said aperture portion are oppositely disposed from one another along said longitudinal axis, said surrounding sidewall having an outer surface and an opposing inner surface, said flexible surrounding sidewall inner surface, said base, and said aperture portion defining an interior of said vessel that contains a fluid, wherein operationally manually squeezing said flexible surrounding sidewall results in the fluid being expelled therethrough said aperture portion from said vessel interior to an external environment, further included is a message display face that is constructed of a printed ink waterproof flexible layer that is applied to a portion of said flexible surrounding sidewall outer surface, said printed ink waterproof flexible layer facing the external environment, and a message inscription implement that is adjacent to said vessel, said message inscription implement has an ink that can create a message on said printed ink waterproof flexible layer while wet with water, further said implement ink can be manually removed from said printed ink waterproof flexible layer, to operationally facilitate a message to be added and removed from said message display face in a water wet external environment;
(b) writing an exercise routine on said message display face using said message inscription implement;
(c) completing said exercise routine and using said vessel and said fluid for hydration; and
(d) cleaning off said exercise routine writing from said message display face with a solvent.

18. A method of using a message creation and display vessel according to claim 17 wherein said cleaning step solvent is selected from the group consisting of ketones.

19. A method of using a message creation and display vessel according to claim 18 wherein said cleaning step solvent ketone is acetone.

20. A method of using a message creation and display vessel according to claim 17 further comprising a step of washing said vessel.
